(19) United States
(12) Patent Application Publication
(10) Pub. No.: US 2001/0017170 A1
(43) Pub. Date: Aug. 30, 2001

(54) Cutter head

(76) Inventor: Herbert Thomas, Memmingen (DE)

Correspondence Address: Richard B. Hoffman, Marshall, O'Toole, Gerstein, Murray & Borun, 6300 Sears Tower, 233 South Wacker Drive, Chicago, IL, 60606-6402, US

(21) Appl. No.: 09/777,075

(22) Filed: Feb. 5, 2001

(30) Foreign Application Priority Data
Feb. 8, 2000 (DE) 100 05 467.6

(51) Int. Cl. B27C 1/00; B27C 5/00; B27G 13/00

(52) U.S. Cl. 144/230

(57) ABSTRACT

Cutter head for wood working machines comprising a carrier with at least one receptacle for detachably receiving a cutter unit and a means for adjusting the flight circle of a cutting edge of the cutter unit, wherein in order to facilitate such a cutter head in view of the manufacture and installation thereof and to improve the resharpening ability of the cutter unit, the adjusting means comprises at least one spacer arranged between the cutting edge and the receptacle in an exchangeable manner and defining the distance between the cutting edge and a bearing surface of the receptacle.

The invention relates to a cutter head for wood working machines of the type explained in the preamble of claim 1.

Such cutter heads are, for instance, used for milling, profiling or planing wood, and, depending on the required cutting performance and the material to be processed, they may be equipped with compact cutters made of the usual cutting steels or with hard metal cutting plates and support plates placed underneath.

A cutter head for wood working machines having a hard metal cutting plate and a support plate placed underneath is known from EP 726 838 B1. In order to guarantee that the cutting edge can rotate again on the same flight circle also after it has been resharpened, the cutting plate can be adjusted. For this purpose the cutting plate comprises a micro toothing on the reverse side thereof engaging into a corresponding micro toothing of the support plate. The micro toothings extend axially relative to the flight circle and have a predetermined distance radially thereto. If the cutting plate needs resharpening, the pressure of the cutting plate acting against the support plate is released and the cutting plate is offset outwardly relative to the support plate by one tooth of the micro toothing. Thus the cutting plate can be resharpened in a manner that the cutting edge is positioned again on the previous flight circle after the resharpening. The possibility of adjustment by micro toothings engaging each other, however, has essential disadvantages. On one hand it is not excluded that the cutting place is inadvertently adjusted by more than one tooth, with the result that more of the expensive hard metal material than would be actually necessary is cut off. Also the mounting of the known cutter unit is difficult, since it has to be secured that the selected engagement points of the micro toothing are maintained also when the cutter unit is inserted and tightened. Moreover, the micro toothings must come up to requested dimensions and must be manufactured with precision, which in view of hard metal cutting plates is possible only with expensive diamond tools. Finally, the cutting plate is in a radial direction only supported on the support plate by the relatively small oblique surfaces of the micro toothing, so that relatively high pressure forces are required.

Therefore, the invention is based on the object to provide an easy to manufacture and easy to mount cutter head offering good support of the cutter unit in a radial direction.

The object is provided by the features described in claim 1.

By the embodiment according to the invention the mode of adjusting the cutter unit is exactly predefined by the previously selected spacer without involving the risk that said predefinition is inadvertently changed during the installation of the cutter unit in the receptacle on the carrier. Moreover, a good support on the carrier is achieved by means of the spacer. Said spacers may be used for cutter units consisting of a compact cutter made of the usual cutting steels as well as for cutter units consisting of a hard metal cutting plate and a support plate.

If an adjustment in more than two grades is desired, the spacers should usefully be provided in a set described in claim 2.

By the step according to claim 3 the radial support is improved.

By the step according to claim 4 the spacer may be fastened to the cutter unit in advance so that the mounting of the cutter unit is facilitated.

Especially advantageous is the use of the embodiment according to the invention in a cutter unit comprising, in accordance with claim 5, a cutting plate and a support plate.

Claim 6 describes a first preferred possibility to dispose the spacer between the cutting edge and the receptacle.

Claim 7 describes an additional possibility to dispose the spacer between the cutting edge and the receptacle.

By the step according to claim 8 the positional security of the spacer relative to the cutter unit is improved.

Claim 9 describes a particularly preferred embodiment of the spacer.

The embodiment of the pressure jaw described in claim 10 facilitates the mounting additionally. Claims 11 and 12 describe a particularly preferred embodiment of the pressure jaw facilitating both the mounting of the cutter unit and the adjustment thereof.

The embodiment of the pressure jaw described in claims 13 and 14 generates a pressure force component acting inwardly in radial direction so as to facilitate the mounting and so as to guarantee a firmer seat of the cutter unit in the receptacle.

Claim 15 describes a preferred embodiment for a set of spacers used for the cutter head according to the invention.

Embodiments of the invention will hereinafter by explained in more detail by means of the drawings, wherein

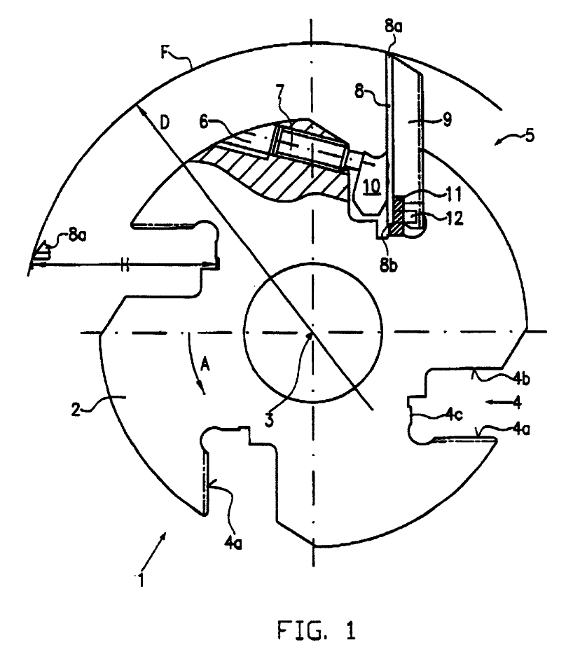

FIG. 1 shows a top view on a cutter head constructed according to the invention in a schematic illustration,

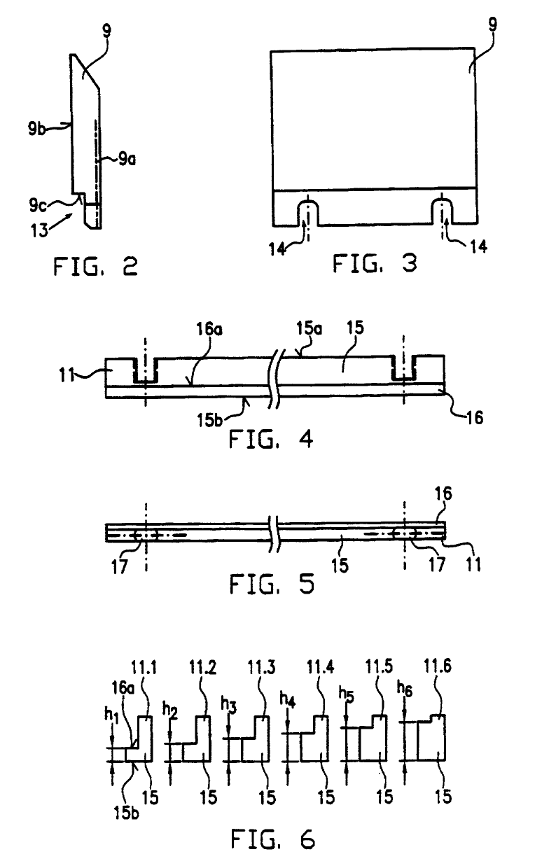

FIG. 2 shows the support plate of FIG. 1 in a lateral view,

FIG. 3 shows the front view of FIG. 2,

FIG. 4 shows the front view of the spacer of FIG. 1,

FIG. 5 shows the top view on the spacer of FIG. 1,

FIG. 6 shows a lateral view of a set of spacers for the cutter head according to FIG. 1,

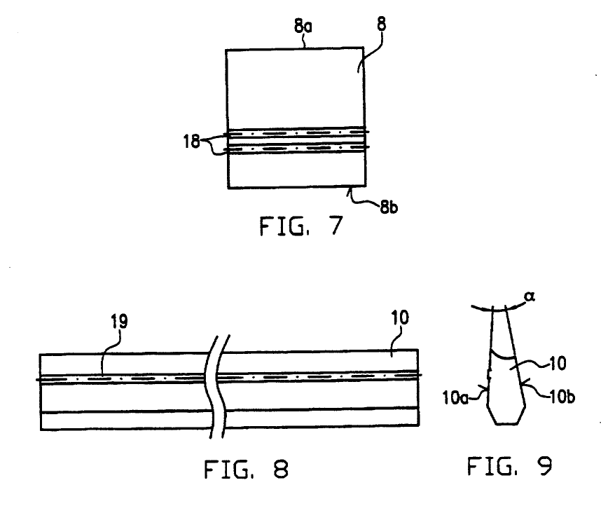

FIG. 7 shows a front view of a cutting plate usable for the cutter head according to FIG. 1,

FIG. 8 shows a front view of a pressure jaw usable for the cutter head according to FIG. 1,

FIG. 9 shows the lateral view of the pressure jaw according to FIG. 1,

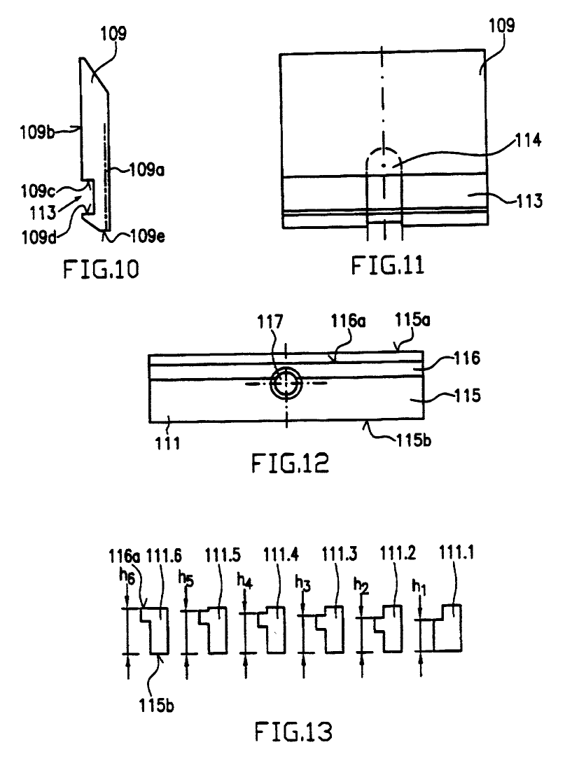

FIG. 10 shows a lateral view of another embodiment of a support plate for a a cutter head according to the invention,

FIG. 11 shows the front view of FIG. 10,

FIG. 12 shows the front view onto a spacer for the support plate according to FIG. 10,

FIG. 13 shows the lateral view onto a spacer set for the support plate according to FIG. 10, and

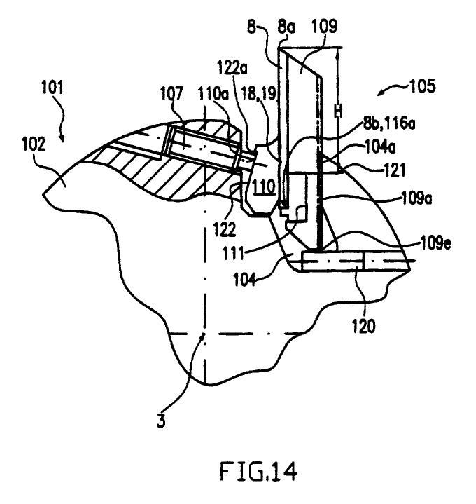

FIG. 14 shows a top view on another embodiment of a cutter head according to the invention.

FIG. 1 shows a cutter head 1 constructed according to the invention, which, in the present embodiment, is designed as a milling cutter for wood working. The cutter head 1 comprises a cylindrical carrier 2, which, in the wood working machine, is rotatably driven in the direction of arrow A about a rotational axis 3 extending perpendicularly to FIG. 1. In the present embodiment four receptacles 4 for respectively one cutter unit 5 are distributed at regular intervals over the circumference of the carrier 2. Each of the receptacles 4 is, as is normal with said cutter heads, designed as a groove extending in axial direction relative to the rotational axis 3 and open in circumferential direction. Flanks 4a of each of the receptacles 4 after-running in the rotational direction A are designed as support surfaces for the cutter units 5 with flanks 4a of all receptacles 4 having the same alignment relative to the rotational axis 3 and the circumference of the carrier 2 and, if four cutter units 5 are used, being positioned to each other at right angles. The usual micro toothing may be disposed on flanks 4a, whereby the micro toothing, in the illustrated embodiment, serves the support against centrifugal forces during the operation and as positioning aid during the installation of the cutter unit, and which is shown in FIG. 1 in a dot-dash line.

Flanks 4b positioned opposite flanks 4a of each receptacle 4 are interspersed with an opening 6, in which a fastening bolt 7 or the like for fastening the cutter unit 5 in the carrier 2 can be accommodated and lowered beneath the surface of the carrier 2.

The base of each receptacle 4 has a bearing surface 4c, which is preferably slightly raised over the remaining lower periphery of the receptacle 4 and which is exactly aligned to the flank 4a in view of its angular position, i.e., in the present embodiment, it forms a right angle with flank 4a.

Each cutter unit 5 comprises in the illustrated embodiment a cutting plate 8 of hard metal having a cutting edge 8a, a support plate 9 placed behind the cutting plate 8, a pressure jaw 10 placed between bolt 7 and cutting plate 8 and a spacer 11 acting as will be explained hereinbelow—as adjusting means, which is detachably connected with the support plate 9 by a catch spring 12.

Each of the cutter units 5 is disposed in the receptacle 4 such that the cutting edges 8a of all cutting plates 8 rotate on a common flight circle F with the diameter D about the rotational axis 3. Diameter D of the flight circle F should preferably be maintained also after the cutting edges 8a have been resharpened.

The components of each cutting unit 5 will hereinafter be explained by means of FIGS. 2 to 9. As is shown in FIGS. 2 and 3 the support plate 9 may comprise a toothing 9a corresponding to the toothing of flank 4a resulting, apart from the pressure force cause by bolt 7, also in a form-fit engagement between the flank 4a of the receptacle 4 and the support plate 9. On the side opposite the toothing 9a the support plate 9 is provided with the support surface 9b for the cutting plate 8. In the area of the support plate 9 facing the base of the receptacle 4 a recess 13 is formed in the support surface 9b, which extends over the total axial width of the support plate 9 in the direction of the rotational axis 3 and which is open inwardly, i.e. in the direction of the rotational axis 3. The periphery 9c of recess 13 radially facing inwardly extends perpendicularly to the toothed reverse side 9a and to the support surface 9b so as to extend essentially parallel to the bearing surface 4c in the receptacle 4 and being positioned directly opposite thereof during the installation of the cutter unit 5. Two grooves 14 end in said recess 13 for fastening the catch spring 12.

The recess 13 is designed so as to accommodate the spacers 11 illustrated in FIGS. 4 to 6. The spacer 11 has a ledge-shaped basic body 15 having an upper side 15a and a likewise ledge-shaped shoulder 16 projecting from one of the two wider sides of the basic body 15 and being preferably designed to be integral with the basic body 15. Basic body 15 and shoulder 16 preferably have the same axial length as the support plate 9. On the upper side of the shoulder 16 a first bearing surface 16a is provided. The underside of the shoulder and basic body are flush and form a second bearing surface 15b. The upper side 15a of the basic body 15 corresponds in view of width and length essentially to the periphery 9c of the recess 13 of the support plate 9, so that the periphery 9c is supported on the upper side 15a, if the spacer 11 is received in the recess 13 and if no toothing is provided between the support plate 9 and flank 4a. If a toothing is provided, both surfaces 9c and 15a may have a distance to each other, which should be smaller or equal to half the tooth pitch (about 0.8 mm). In both cases the shoulder 16 projects over the support surface 9b so that the cutting plate 8 stands on the bearing surface 16a with its inwardly facing bearing surface 8b. Also the spacer 11 is provided with grooves 17, which, in a top view, are designed as part of a bore for receiving the catch spring 12, i.e. they have undercut peripheries.

By means of the spacer 11 it is possible to displace the cutting plate 8 relative to the support plate 9 and the rotational axis 3 further radially from the rotational axis 3 in an outward direction once the cutting edge 8a has been used up, so that the cutting edge 8a of the cutting plate 8 is positioned again with diameter D on the flight circle F after the resharpening, i.e. it has essentially the same distance H to the bearing surface 4c as it had prior to the resharpening. In principle this is feasible with only one spacer if a single adjusting possibility is enough, whereby the cutting plate 8 stands with its bearing surface 8b on the bearing surface 4c of the receptacle 4 prior to the resharpening and is placed with its bearing surface 8b onto the bearing surface 16a of the single spacer after the sharpening.

Preferably, however, a set of spacers 11 in different dimensional grades is provided, as is shown in FIG. 6. FIG. 6 shows a set of six spacers 11.1, 11.2, 11.3, 11.4, 11.5 and 11.6, whereof each shows an identically dimensioned basic body 15, however, staggered distances h (h₁, h₂, h₃, h₄, h₅, h₆) between the bearing surface 15b resting on the bearing surface 4c in the receptacle 4 and the bearing surface 16a on which rests the bearing surface 8b of the cutting plate 8.

If the cutting edge 8a is now to be resharpened, the user merely has to remove the cutter unit 5 from the receptacle 4, separate the possibly already used spacer 11 from the support plate 9 by releasing the catch spring 12, fasten the spacer of the following dimensional grade, for example, spacer 11.2, again on the support plate 9 by means of catch spring 12, insert the cutting plate 8 and fasten it again in the receptacle 4 by tightening bolts 7. Afterwards cutting edges 8a may be resharpened and the predetermined flight circle diameter D may be cut in again. The spacers 11 are sufficiently large to have them provided with a clearly visible mark so as to facilitate the exchange and to make sure that always the spacer of the directly following dimensional grade is used, so that an inadvertent higher adjustment of the cutting plate can no longer occur.

The mounting and the adjustment of the cutting plate 8 is improved by the form-fit connection between the cutting plate 8 and the pressure jaw 10 shown in FIGS. 7 to 9. As is shown in FIG. 7, the cutting plate 8 has two parallel grooves 18 extending in the rotational direction of the rotational axis 3, which are disposed at a spot of the cutting plate 8 positioned inside the receptacle 4 and opposite the pressure jaw 10, even if the cutting plate 8 was resharpened to the last possible dimension. It is not absolutely required that the grooves 18 are produced as dimensionally accurate and precise as the toothing between the support plate 9 and the flank 4a.

As is shown in FIGS. 8 and 9, the pressure jaw 10 has a shoulder 19 on the surface 10a facing the cutting plate 8 which is so dimensioned that it can immerse into the grooves 18 while the surface 10a presses against the cutting plate 8. Also the shoulder 19 extends over the entire axial length of the pressure jaw 10.

Opposite surface 10a a contact surface 10b for the bolt 7 is provided on the pressure jaw 10, which is even, straight and long enough in radial direction to the flight circle F that the bolt 7 finds a plurality of contact points. The contact surface 10b and surface 10a are inclined towards each other by an acute angle α, whereby the point having the greatest distance between surfaces 10a and 10b is arranged radially internally in view of the flight circle F. The angle α is so dimensioned that surface 10b extends essentially in the direction of diameter D of the flight circle F about the rotational axis 3 when the pressure jaw 10 is installed. Thus, if the bolt 7 contacts surface 10b a component of the fastening force acting radially inwardly is produced, which assists to retain the cutter unit 5 in the receptacle 4 even though the receiving recesses for bolts 7 known from the prior art are not provided. This allows an essentially infinitely variable alteration of the mutual position of bolts 7 and pressure jaw 10.

Due to the engagement of the shoulder 19 of the pressure jaw 10 with one of the two grooves 18 the pressure jaw 10 can thereby, during the installation, be positioned in its position relative to the cutting plate 8 and the support plate 9, so that the insertion is substantially facilitated. Depending on the spacer 11 used, the groove radially positioned further outside or radially positioned further inside is selected for a form-fit engagement of the shoulder 19, whereby the contact point of the bolt 7 on the surface 10b is infinitely variable.

FIGS. 10 to 14 show another embodiment of a support plate 109 comprising an associated spacer 111. The support plate 109 differs from the support plate 9 by the arrangement and the design of a recess 113, which, in the present embodiment, is designed as a groove extending over the entire axial length of the support plate 109. The recess 113 contains a bearing surface 109c facing radially towards the inside and a bearing surface 109d facing radially towards the outside. The support plate 109 may likewise be provided with a back toothing 109a. If this is not the case, the side of the support plate 109 facing radially towards the inside can be provided with another bearing surface 109e underneath recess 113, with which bearing surface 109e the support plate 109 is supported on a bearing surface 4c of the receptacle 4.

In said embodiment the support plate 109 is provided with a guiding mechanism for screws 114 for screwing the spacer 111. In the guiding mechanism for the screw 114 a non-illustrated slider may be received, which is defined in the predetermined position by a screw interspersing the support plate 109 and a screw opening 117 in the spacer 111.

FIGS. 12 and 13 show spacers 111 to be used in the support plate 109. Each of the spacers 111 is provided with the same ledge-shaped basic body 115 the dimensions of which are so selected that it is accommodated in the recess 113, whereby each of the outwardly and inwardly facing peripheries 115a and 115b of the basic body 15 dash against the inwardly and outwardly facing bearing surfaces 109c and 109d of the support plate 109.

On the side facing the cutting plate 8 the basic body 115 is provided with a ledge-shaped shoulder 116 carrying on its radially outwardly facing side the bearing surface 116a for the bearing surface 8b of the cutting plate 8. Said shoulder 116 projects over the support surface 109d of the support plate 9.

Analogously to the first embodiment a set of spacers 111 (111.1, 111.2, . . . 111.6) is provided in different dimensional grades, i.e. with different distances h (h₁, h₂, . . . h₆) between the bearing surface 116a and bearing surface 115b.

FIG. 14 shows another embodiment of a cutter head 101 in an illustration according to FIG. 1, which, however, comprises the cutter unit according to FIGS. 10 to 13. The support plate 109 is provided with a back toothing 109a engaging into a back toothing 104a of a slightly modified receptacle 104. A pin 120 is provided on the cutter head extending in the base of the receptacle 104 until underneath the radially internally positioned surface 109e of the support plate 109, which has, however, a distance to surface 109e being smaller or equal to half the tooth pitch of the toothing 109a and 104a thereby serving as a mounting aid in embodiments comprising back toothings, which facilitates the insertion of the cutter unit 105 in the predetermined depth.

The support plate 109 and the body 102 of the cutter head 101 bear a locating mark 121 visually visible from outside, by which the correct position of the support plate 109 in the receptacle 104 is marked. In this embodiment the cutting plate 8 therefore is supported with its lower edge 8b on the bearing surface 116a of the spacer 11 1, and the spacer 111 is supported on the toothing 104a of the receptacle 104 in the carrier 102 via the surfaces of the recess 113 and the back toothing 109a. It is thereby secured by the marking 121 that the support plate 109 is always in the same radial position in the receptacle 104, no matter which of the spacers 111.1 to 111.6 is used.

If a support plate 109 without back toothing is used, the support plate 109 may also be supported with its lower surface 100e on the pin 120, whereby the marking 121 is then not required.

FIG. 14 further shows a modified pressure jaw 110, the surface 110a of which facing bolt 107 is disposed in a recess 122 being open in the direction of the rotational axis 3 of the carrier 102 and limited radially outwardly by a step 122a. The recess 122 is so arranged that the surface 110a again extends essentially radially.

The non-described details correspond to the details of the preceding embodiment.

It is, however, also possible to insert the spacer 11 according to FIGS. 4 to 6 in the recess 113 of the support plate 109 according to FIGS. 10 and 11, whereby the support plate 8 is not supported on the bearing surface 4c by the detour over the support plate 109, but solely by the portion of surface 15b of the spacer 11 projecting out of recess 113.

In modifications of the described and illustrated embodiments the invention cannot only be used for hard metal cutting plates, but, for instance, also for cutters made of common cutting steel (HS, HSS), whereby, in this case, the bearing surface for the support on the spacer is directly provided on the body of the cutter. The invention can, moreover, not only be used for milling cutters, but, for instance, also for plane knives. Also, the constructive design of the spacers is not restricted to the illustrated embodiments. Thus it is conceivable, for instance, to provide, in the embodiment according to FIG. 10, the support plate with a plurality of parallel groove receptacles into which one and the same spacer may be inserted in a height-adjustable fashion. Furthermore, also the spacer according FIGS. 4 to 6 may be fastened to the support plate or the body of the cutter by screwing. In axial direction both the ledge-shaped shoulder 16, 116 on the spacer 11, 111 and the grooves 18 in the cutting plate 8 can only be designed as partial supports, e.g. for a two-point contact. Said shape of the grooves may already be molded without problems into the cutting plate during the sinter-metallurgic production thereof, so that a metal removing molding, which is possible only with special tools, is not necessary.

1. Cutter head for wood working machines comprising a carrier provided with at least one receptacle for detachably receiving a cutter unit, and a means for adjusting the flight circle of a cutting edge of the cutter unit, characterized in that the adjusting means comprises at least one spacer (11, 111) exchangeably disposed between the cutting edge (8a) and the receptacle (4, 104) and defining the distance (H) between the cutting edge (8a) and a bearing surface (4a, 4c, 104a, 120) of the receptacle (4, 104).

2. Cutter head according to claim 1, characterized in that the adjusting means comprises a set of spacers (11.1, . . . 11.6; 111.1, . . . 111.6) in different dimensional grades (h₁, . . . h₆).

3. Cutter head according to claim 1 or 2, characterized in that the spacer (11, 111) is received in a recess (13, 113) of the cutter unit (5, 105).

4. Cutter head according to one of claims 1 to 3, characterized in that the spacer (11, 111) is detachably fastened to the cutter unit (5, 105).

5. Cutter head according to one of claims 1 to 4, characterized in that the cutter unit (5, 105) comprises a cutting plate (8) and a support plate (9, 109).

6. Cutter head according to one of claims 1 to 5, characterized in that the spacer (11) is placed between a bearing surface (8b) on the cutting plate (8) and the bearing surface (4c) arranged in the receptacle (4).

7. Cutter head according to claim 5, characterized in that the spacer (111 ) is arranged between a bearing surface (8b) on the cutting plate (8) and a bearing surface (109c, 109d) on the support plate (109), and that the support plate (109) is supported with a back toothing (109a) on a toothing (104a) of the receptacle (104).

8. Cutter head according to one of claims 5 to 7, characterized in that the support plate (9, 109) is provided with a recess (13, 113) for receiving the spacer (11, 111) which is so dimensioned that a bearing surface (16a, 116a) for the cutting plate (8) projects out of the recess (13, 113).

9. Cutter head according to one of claims 1 to 8, characterized in that the spacer (11, 111) is designed as contact ledge having a ledge-shaped basic body (15, 115) and a ledge-shaped shoulder (16, 116) projecting from the basic body (15, 115), comprising a bearing surface (16a, 116a) for the cutter unit (5) extending over the entire axial length of the cutter unit (5, 105).

10. Cutter head according to one of claims 1 to 9, characterized in that in a cutter unit (5, 105) fastened in the receptacle (4, 104) by means of a pressure jaw (10, 110) a detachable form-fit connection (18, 19) is provided between surfaces facing each other on the pressure jaw (10, 110) and the cutter unit (5).

11. Cutter head according to claim 10, characterized in that the form-fit connection comprises a plurality of shoulders (19) or recesses (18) arranged at a radial distance relative to the flight circle (F) on one of the surfaces and at least one corresponding recess (18) or at least one corresponding shoulder (19) on the other surface.

12. Cutter head according to claim 10 or 11, characterized in that on a pressure jaw (10, 110) which can be pressed against the cutter unit (5, 105) by means of a pressing means (7, 107) contacting a pressure surface (10b, 110b) the pressure surface (10b, 110b) on the pressure jaw (10, 110) offers in radial direction relative to the flight circle (F) a plurality of contact points for the pressing means (7, 107) spaced apart from each other.

13. Cutter head according to one of claims 10 to 12, characterized in that the pressure surface (10b, 110b) on the pressure jaw (10, 110) and the surface (10a) provided with the form-fit connection (18) are inclined towards each other at an acute angle (α), whereby the distance of the two surfaces (10a, 10b, 110b) increases in the direction of the axis (3) of the flight circle (F).

14. Cutter head according to claim 12 or 13, characterized in that the pressure surface (10b, 110b) extends in radial direction relative to the flight circle (F).

15. Spacer set for a cutter head according to one of claims 1 to 14, comprising at least a first and a second spacer (11, 111) whereof each is provided with a basic body (15, 115) and a shoulder (16, 116) having a bearing surface (16a, 116a) for a cutter unit (5, 105), wherein the basic body (15, 115) of the first and the second spacer (11, 111) each has the same width between two lateral edges (15a, 15b, 115a, 115b) extending parallel to the shoulder (16, 116) and wherein the distance (h) of the bearing surface (16a, 116a) of the first spacer (11, 11) to one of the lateral edges (15b, 115b) is different to said distance (h) of the second spacer (11, 111).
